(19) United States
(12) Patent Application Publication
(10) Pub. No.: US 2009/0060481 A1
(43) Pub. Date: Mar. 5, 2009

(54) DEVICE AND METHOD FOR HEATING LIQUIDS

(75) Inventor: Simon Kaastra, Dinxperlo (NL)

Correspondence Address: POWELL GOLDSTEIN LLP, ONE ATLANTIC CENTER FOURTEENTH FLOOR, 1201 WEST PEACHTREE STREET NW, ATLANTA, GA, 30309-3488, US

(73) Assignee: FERRO TECHNIEK HOLDING B.V., Gaanderen (NL)

(21) Appl. No.: 12/064,783

(22) PCT Filed: Aug. 24, 2006
(86) PCT No.: PCT/NL2006/050210

§ 371 Date: Oct. 28, 2008

(30) Foreign Application Priority Data
Aug. 24, 2005 (NL) 1029792

(51) Int. Cl. F24H 1/10; G05D 23/00

(52) U.S. Cl. 392/471; 165/293

(57) ABSTRACT

A device for heating liquids having a base structure and at least one heating element connecting to the base structure wherein at least one non-linear channel structure is arranged between the base structure and the heating element for throughflow of a liquid for heating, and whereas the base structure and the heating element are mutually connected by means of at least one soldered connection. A method is disclosed for heating liquids comprising activating a heating element and guiding a liquid for heating through a channel structure.

### PRIORITY CLAIM

This patent application is a U.S. National Phase of International Patent Application No. PCT/NL2006/050210, filed Aug. 24, 2006, which claims priority to Netherlands Patent Application No. 1029792, filed Aug. 24, 2005, the disclosures of which are incorporated herein by reference in their entirety.

### TECHNICAL FIELD

The present disclosure relates to devices for heating liquids. The disclosure further relates to methods for heating liquids.

### BACKGROUND

Devices for heating liquids have been known for a long time. The applications of these devices can also be of very diverse nature. Such heating devices are already used on a large scale as, or as components in, for instance, water kettles, dish washers, hot water dispensers (for making, for instance, instant soup), coffee-making machines, shower water heaters and the like. In coffee-making machines, for instance, the device is particularly adapted for instantaneous supply of heated water. For this purpose, such a device is generally provided with a tubular body adapted for throughflow of a liquid for heating. During flow through the tubular body, the liquid is heated by a heating element positioned on the tubular body or, conversely, close to the tubular body. Such a method of heating liquids has a number of drawbacks. An issue of known devices is that heating of the liquid takes place with relative difficulty, among other reasons because of the relatively unfavourable (low) area to volume ratio. The length or width of the tube must generally be relatively great in order to be able to realize a desired heating result. The application of a relatively long or wide tubular body generally results in the liquid remaining in the device for a relatively long time, this being required to enable sufficient and desired heating of the liquid. In general, it will take a relatively long time before a user can have the heated water available. Another drawback of known devices is that the outlet temperature of liquid heated by some devices is relatively hard to control since, just after use, a significant amount of preheated liquid is still present within the tubular body, while a significant amount of relatively cold liquid (not preheated) will be present within the tubular body during a long standstill of the device. Heating of the liquid will furthermore take place with relative difficulty due to the relatively inefficient heat transfer from the heating element via the tubular body to the liquid for heating, which also adversely affects the relatively slow heating of the liquid. In addition, the costs for manufacturing some known devices as well as for the use of the device (due to the relatively inefficient heating) are relatively high.

### SUMMARY

The present disclosure describes several exemplary embodiments of the present invention.

One aspect of the present disclosure provides a device for heating liquids, comprising a) a base structure; b) at least one heating element connecting to the base structure; and c) at least one non-linear channel structure arranged between the base structure and the heating element for throughflow of a liquid for heating; wherein the base structure and the heating element are mechanically connected to each other.

Another aspect of the present disclosure provides a method for heating liquids, comprising a) providing a device having a base structure, and at least one heating element connecting to the base structure, wherein at least one non-linear channel structure is arranged between the base structure and the heating element for throughflow of a liquid for heating, and wherein the base structure and the heating element are mutually connected by means of at least one soldered connection; b) activating the heating element; and c) guiding a liquid for heating through the channel structure.

The present disclosure provides a device wherein a liquid can be heated in a relatively efficient and rapid manner.

The present disclosure provides a device, comprising a base structure and at least one heating element connecting to the base structure, wherein at least one non-linear channel structure is arranged between the base structure and the heating element for throughflow of a liquid for heating, and wherein the base structure and the heating element are mutually connected by means of at least one soldered connection. The channel structure is, in fact, bounded and formed by both the base structure and the heating element. Heat can thus be transferred directly, without interposing another element, and, therefore, relatively efficiently from the heating element to the liquid for heating. Particularly when liquid is driven through the channel structure having a relatively small liquid volume at relatively high speed, it is possible to achieve a relatively efficient and rapid heat transfer per unit of liquid volume per unit of time. An additional feature is that precipitate, such as, for instance, limescale, cannot appreciably be deposited in the channel structure, or at least hardly so, as a result of the relatively high rate of flow of the liquid, which results in a relatively low-maintenance device. Because the channel structure takes a non-linear form, the contact surface between the heating element and the liquid for heating situated in the channel structure can be maximized, which, in addition to a relatively rapid heating of the liquid to a desired temperature, also results in a relatively compact device for heating liquids rapidly and efficiently. Furthermore, the application of the device according to the present disclosure, which functions in respect of energy, generally results in cost-saving. Another feature of at least one exemplary device according to the present disclosure is that a relatively strong assembly is created due to the physical (direct), non-releasable connection between the base structure and the heating element, wherein the channel structure can be sealed in relatively reliable, durable and firm manner. The mutual attachment of the heating element and the base structure results in a device which can withstand relatively high liquid pressures (up to about 35 bar), whereby liquid can be guided through the channel structure under relatively high pressure. When the heating element and the base structure are only clamped to each other in a laterally releasable manner, such a reliability of the sealing of the channel structure cannot be realized, or at least only with great difficulty, wherein a large number of components would have to be applied to seal the device which would result in a relatively voluminous and expensive device. By having the base structure and the heating element attached (connected) directly to each other, a device can thus be provided in a relatively simple yet firm, durable and reliable manner through which a liquid for heating can be guided under relatively high pressure (about 35 bar), whereby large quantities of liquid can be heated to a desired temperature relatively quickly. A further feature of at least one exemplary device according to the present disclosure is that, by applying the channel structure arranged between the base structure and the heating element, the area to volume ratio of the channel structure can be optimized in relatively simple manner for determined applications, for instance, by giving the channel or the channels of the channel structure a relatively flat (shallow) form, whereby the channel structure acquires only a limited volume which can considerably improve the temperature increase of the liquid for heating per unit of time. Owing to the significantly improved heating of the liquid per unit of time, the throughput time of the liquid through the device can be reduced considerably, whereby the user can have the heated liquid available relatively quickly. The liquid can be guided through the channel structure at a flow rate of up to several meters per second, preferably between 1 and 3 meters per second. Such a relatively high flow rate is usually particularly advantageous since, in this manner, the generation of vapor bubbles can be avoided or at least counteracted. Vapor bubbles rarely formed within the channel structure will generally be flushed immediately out of the device. Such a relatively high flow rate prevents deposition of contaminants such as limescale and the like on the heating element and/or the base structure. Deposition of contaminants on the heating element is particularly disadvantageous for the heat transfer from the heating element to the liquid for heating. It is noted that the non-linear channel structure is provided with one or more non-linear channels which are optionally parallel to each other, wherein the liquid for heating preferably passes through a non-linear, two-dimensional, in particular, spiral-shaped route. It is, however, also very possible here to envisage parts of the channel structure taking a linear form, but wherein the liquid passes through the device via a labyrinthine route.

As stated above, the device according to the present disclosure is adapted to withstand relatively high pressures as a result of the physical mutual connection of the heating element and the base structure. A liquid can be guided through the channel structure of the device under relatively high (test) pressure (up to about 35 bar) compared to (operating) pressures (up to about 16 bar), whereby the liquid can be heated to a desired temperature relatively rapidly. In order to generate a firm, direct coupling between the heating element and the base structure, the base structure and the heating element are mutually connected by means of at least one soldered and/or brazed connection. The common advantage of a soldered and brazed connection is that such a connection is relatively strong and durable and allows the application of relatively thin dividing walls bounding the channel structure. Since commonly the soldered or brazed connection is relatively long (typically up to 10 meters), the application of a channel structure bound by one or multiple relatively thin dividing walls being connected to the heating element by means of soldering or brazing is commonly favorable for the cost price of the heating device. Preferably, the dividing wall has a thickness of between 0.1 and 0.8 mm, and, in particularly, of between 0.1 and 0.5 mm. In practice, it is expected that a wall thickness of between 0.1 and 0.5 mm will be sufficient to withstand liquid pressures during stand still and during operation of the device. For purposes of the present disclosure, brazing is defined as a group of joining processes that produce coalescence of materials by heating them to the brazing temperature and by using a filler metal (solder) having a liquidus temperature above 840° F. (450° C.). For purposes of the present disclosure, soldering is defined as a group of joining processes that produce coalescence of materials by heating them to the soldering temperature and by using a filler metal (solder) having a liquidus temperature below 840° F. (450° C.). A soldered connection is, moreover, heat-conducting, whereby heat generated by the heating element can be transferred to the base structure relatively rapidly, easily and without much heat loss to enable heating of the liquid for heating in an improved and, therefore, accelerated manner. The soldered connection can be formed by one or more soldering points, but can also be formed by a solder layer. In this case, the solder layer will generally have a thickness which can vary from several micrometres to several millimetres. The soldered connection preferably comprises at least one soldered seam. By applying one or more soldered seams, the base structure and the heating element can, on the one hand, be mutually attached in firm manner, and the channel structure can, on the other hand, be sealed in substantially medium-tight manner so that leakages of liquid from the device can be prevented. The soldered seam preferably extends along at least a part of a contact surface formed by the base structure and the heating element. It is even possible here to envisage substantially the whole contact surfaces of the base structure and the heating element being provided with solder for the purpose of forming the soldered connection. The soldered connection is generally formed by a mixture of high-melting metals, such as, for instance, a nickel-based solder, whereby the soldered connection can be realized in relatively simple manner and is moreover thermally conductive.

In one exemplary embodiment, at least a part of the channel structure is arranged recessed into an outer surface, in particular, a side directed toward the heating element, of the base structure. The channel structure can already be prearranged in the base structure during manufacture of the base structure, but can also be arranged in the base structure at a later stage. The base structure is generally formed by a plastic and/or metal carrier layer in which one or more non-linear channels are arranged. The channel structure can be arranged as a cavity in the base structure. The channel structure will generally be laterally bounded on one or more sides by a dividing wall. The dividing wall is preferably connected to the heating element via the soldered seam, while forming a seal for the channel structure in order to enable optimal sealing of the channel structure and thus prevent liquid leakages. In another exemplary embodiment, the base structure comprises a base plate on which the dividing wall is arranged by means of at least one welded connection. The welded connection is generally formed by a welded seam. In this manner, a medium-tight and relatively pressure-resistant device can be provided, which can already be tested for possible leakages just after assembly, and not only after the base structure and the heating element are finally clamped to each other via a separate (conventional) clamping construction. After assembly, the device has a supply opening and a discharge opening for liquid, and preferably also one or more receiving spaces for receiving one or more (thermal) sensors. In order to further improve the sealing of the device and, in particular, of the channel structure, the dividing wall is preferably integrally connected to the base plate. In this manner no leakages can be present between the dividing wall and the base plate. More preferably, the dividing wall is at least partially formed by a deformed part of the base plate. According to this exemplary embodiment, the base plate is commonly die-cut (punched) by means of a punching apparatus after which parts of the punched base plate are bent as to form the at least one dividing wall. It is conceivable that the dividing wall as generated is provided with one or multiple additional bends to increase the contact surface area between the dividing wall and the heating element, which commonly facilitates mechanically connecting, in particularly, brazing, the dividing wall to the heating element. Preferably, the base plate and the dividing wall (being a former part of the base plate) are preferably substantially made of steel, in particularly, stainless steel. It has been found that steel, in particular, stainless steel, is ideally suitable to be brazed to the heating element. In case a punched base plate (provided with the dividing wall) is applied, the base structure preferably also comprises at least one shielding element for shielding the base structure at least partially. The shielding element is more preferably connected to the heating element and/or the base plate to achieve a substantially medium-tight and relatively pressure-resistant device.

In another exemplary embodiment, at least a part of the channel structure is arranged recessed into the heating element. In such an exemplary embodiment, the contact surface between the heating element and the liquid for heating can thus be increased, which will generally result in a more intensive and more rapid heating. It is also possible to envisage arranging the channel structure as a cavity pattern in the base structure wherein the heating element is provided with a counter-cavity pattern connecting to the cavity pattern.

The channel structure in one exemplary embodiment comprises a substantially two-dimensional geometry in order to enable a relatively flat exemplary embodiment of the device, which can be desirable for building the device into specific applications such as coffee-making machines. The manufacture of a device provided with a two-dimensional geometry is relatively simple. Although it will generally be less recommended due to the generally relatively costly method of manufacture, it is, however, also possible to envisage providing the channel structure with a three-dimensional geometry since a relatively compact device can still be thus manufactured. The channel structure preferably has an at least partly curved and, in particular, spiral-shaped design. A spiral-shaped progression of the channel structure is generally relatively advantageous because the contact surface between the liquid for heating and the heating element (and the base structure) can be maximized, which can significantly improve the heat transfer per unit of time. In the case a channel structure is applied with a substantially spiral-shaped, zigzag-shaped or equivalent progression, the channel structure will be laterally bounded by only a single (identically curved) dividing wall. By attaching this dividing wall to the heating element by means of a soldered connection, a substantially medium-tight channel structure, and thereby device, can be obtained whereby liquid can be heated in relatively effective and efficient manner.

The heating element is preferably given a substantially plate-like form. Plate-like heating elements are already known commercially and can generally be manufactured relatively cheaply. It is moreover usually advantageous from a structural viewpoint to use a flat heating element. In this case, the heating element is generally formed by an electrical heating element which is preferably provided on a side remote from the channel structure with a track-like thick film for forced conduction of electric current in order to be able to generate the desired heat.

In another exemplary embodiment, the channel length of the channel structure lies between 0.3 and 7 metres, in particular, between 0.5 and 5 metres, more preferably is substantially 2 metres. Such a length is generally sufficient to heat liquid such as water, oil, and so on from room temperature to a temperature of more than 90 degrees Celsius. Since the channel structure has a non-linear form, the volume taken up by the channel structure will be relatively limited, which enhances handling of the device.

In yet another exemplary embodiment, the cross-section of the channel structure has a surface area lying between 1 and 100 mm², in particular between 2 and 50 mm². The exact area generally depends on the specific application of the device. A device for heating water for making tea or coffee thus preferably has a cross-section between 2 and 5 mm². For heating water which can then be drawn off via a tap, usually a shower tap or bath tap, a channel structure having a cross-section between 10 and 60 mm is preferably applied. The same cross-section can, for instance, also be applied for heating frying oil.

The non-linear channel structure is preferably given an at least partly angular form. By arranging one or more angles in the channel structure, a two-dimensional or optionally three-dimensional flow progression of the liquid for heating can be realized. The liquid can thus be guided relatively efficiently along the relatively compact heating element and thus heated to a desired temperature. In another exemplary embodiment, the channel structure is given an at least partly curved form. By giving the channel structure a substantially spiral form, liquid can, for instance, likewise be heated to a desired temperature in relatively compact and intensive manner. In an exemplary embodiment, the base structure comprises a composite strip of a relatively high metal band and a relatively low metal band connected to the relatively high metal band, wherein the strip wound up in spiral form does, in fact, form the channel structure. The thermally conductive metal bands can, for instance, be formed by strip steel. A channel structure with a cross-section of 2×2 millimetres can, for instance, be formed by rolling up a composite strip of strip steel with a height of 6 millimetres and a thickness of about 0.1 millimetres, having attached thereto another strip steel with a height of 4 millimetres and a thickness of 2 millimetres. In an alternative exemplary embodiment, the composite strip can also be given an integrated construction of a higher strip part and an adjacent, lower strip part. Although the metal strip is generally relatively rigid, the wound composite strip nevertheless possesses a certain flexibility since mutually adjacent strip parts of the strip can slide relative to each other. Such a flexible character is particularly advantageous in being able to compensate (considerable) deformations of the heating element, and thereby resulting height differences, during heating of the heating element, wherein the strip can connect permanently to the heating element in reliable and medium-tight manner irrespective of the degree of deformation of the heating element, whereby leakages of liquid, and gases evaporating therefrom, from the device can be prevented. In order to allow permanent connection of the strip to the heating element and to allow for de facto compensation for deformation of the heating element, the base structure, in particular, the strip, is connected to the heating element by means of a soldered connection whereby the formation of gaps between the heating element and the base structure can thus be prevented.

In yet another exemplary embodiment, the base structure is formed by a plurality of separate, mutually connected base modules. The base modules can be of very diverse nature and can, for instance, be formed by partitions which are held at a mutual distance by spacers, wherein the relative orientation of the base modules determines the channel structure.

The device is preferably provided with a pump for pumping the liquid for heating through the channel structure under pressure. Because liquid can be heated relatively rapidly, intensively and efficiently using the device according to the present disclosure, the liquid flow rate through the channel structure can be increased so as to prevent excessively intensive heating of the liquid on the one hand and to increase the capacity of the device on the other. The pump flow rate of the pump, i.e., the number of units of liquid volume per unit of time, can preferably be regulated. It can be advantageous to regulate the pump flow rate so as to be able to meet the user requirement in relatively simple manner. If a quantity of liquid with a desired final temperature is, for instance, required, the pump flow rate can be adjusted (temporarily) to be able to meet the requirement of the user relatively quickly. In a particular exemplary embodiment, the device is provided with sensor means coupled to the pump to enable the pump flow rate to be regulated subject to the liquid temperature in the channel structure. The sensor means are herein preferably positioned before the device to measure the temperature of the relatively cold liquid. Together with a desired final temperature of the liquid and the heat-transfer capacity of the heating element, it is thus possible to calculate and apply the most ideal pump flow rate without any delay occurring in the heating system, this latter in contrast to the situation in which the sensor means are positioned after the device and are adapted to detect the temperature of the heated liquid. By adjusting the pump flow rate, it is, for instance, possible to prevent the liquid becoming overheated in the channel structure. When one or more critical temperatures are exceeded, the pump flow rate can be increased so that overheating can be prevented. However, in the case of overheating, commonly the heating element is switched off at least partially. In the case the liquid temperature in the channel structure is relatively low, if the heating element has, for instance, just been switched on, the pump flow rate can be (temporarily) reduced in order to increase to some extent the length of stay of the liquid in the channel structure, whereby an improved heating of the liquid can be achieved. It is noted in this respect that the device can also be connected to a conventional water main, commonly being a public water supply system, which water main may also function as a pump. The pump flow rate can also be controlled by applying a tap, suitable valve, or other control member. In a particular exemplary embodiment, the device comprises at least one inlet sensor for detecting the temperature of the liquid supplied to the device and at least one outlet sensor for detecting the temperature of the liquid guided out of the device, whereby the temperature change of the liquid in the channel structure can be measured. In combination with measuring the power supplied to the liquid by the device, it is then possible to determine the volume of the supplied heated liquid which may be relevant, particularly in the case that a determined volume of liquid is desired at a determined temperature. One application hereof is, for instance, dispensing a volume of a hot drink, for instance, at a determined temperature. Preferably, the device comprises a control unit for regulating the pump flow rate based upon temperature related information gathered by the sensor means. In case the actual outlet temperature is below a desired outlet temperature, the flow rate may be reduced by the control unit. Conversely, in case the actual outlet temperature exceeds the desired outlet temperature, the flow rate may be increased by the controlling unit. Commonly, the heat capacity (power) of the heating element is known. Since the dimensioning of the channel structure is also known, the rise in temperature of the liquid during flowing through the channel structure can be calculated by the controlling unit for each flow rate. Based upon the sensed and/or known inlet temperature of the liquid and the desired outlet temperature, the optimum flow rate can be determined by the control unit.

The present disclosure also relates to a method for heating liquids using a device according to the present disclosure. One exemplary method comprises a) activating a heating element as described herein, and b) guiding a liquid for heating through a channel structure as described herein. Guiding of the liquid for heating through the channel structure as disclosed in step b) preferably takes place under increased pressure. This pressure can rise to about 35 bar. Several features of the method according to the present disclosure have already been described at length hereinabove. In an exemplary embodiment, the method further comprises step c) detecting the temperature of the liquid at an inlet and/or an outlet of the channel structure. In one particular exemplary embodiment, the method further comprises a step d) regulating the flow rate of the liquid guided through the channel structure in step b) based upon the at least one temperature detected according to step c). By allowing the pump rate flow to be adapted, the outlet temperature of heated liquid leaving the device can be maintained substantially at a desired outlet temperature, regardless that the desired outlet temperature is held at a preset constant temperature or that the desired outlet temperature is adjusted and varies in the course of time.

### BRIEF DESCRIPTION OF THE DRAWINGS

Various aspects of the present disclosure are described hereinbelow with reference to the accompanying figures in which the part numbers refer to like parts throughout the several drawings.

FIG. 1 is a partly cut-away perspective view of one exemplary embodiment of a device according to the present disclosure;

FIG. 2a is a cross-section of a second exemplary embodiment of a device according to the present disclosure;

FIG. 2b is a cross-section view along the line A-A of FIG. 2a;

FIG. 3 is a schematic representation of another exemplary embodiment of a device according to the present disclosure;

FIG. 4a is a partly cut-away top view of yet another exemplary embodiment of a device according to the present disclosure;

FIG. 4b is a cross-section view along the line C-C of FIG. 4a;

FIG. 5a is a perspective view of an alternative exemplary embodiment of a device according to the present disclosure;

FIG. 5b is a perspective view of a base structure of the device of FIG. 5a;

FIG. 5c is a perspective view of a part of the base structure of FIG. 5b;

FIG. 5d is a part of a cross-section view of the device of FIG. 5a; and

FIG. 6 is a part of a cross-section view of yet another alternative exemplary embodiment of a device according to the present disclosure.

### DETAILED DESCRIPTION

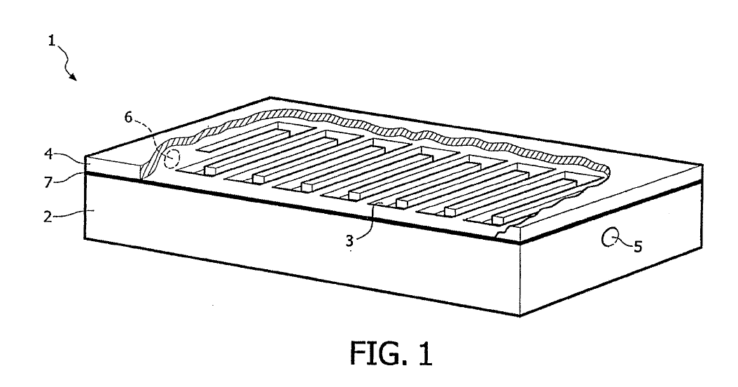

FIG. 1 shows a partly cut-away perspective view of a device 1 according to a first exemplary embodiment of the present disclosure. Device 1 comprises a base structure 2 and a heating element 4 connecting thereto in substantially medium-tight manner. Between base structure 2 and heating element 4, and, in particular, in an upper surface of base structure 2, is arranged a non-linear, two-dimensional channel structure 3 for guiding a liquid for heating along heating element 4. The liquid for heating is pumped into channel structure 3 via a supply opening 5 and after being heated leaves channel structure 3 via a discharge opening 6. FIG. 1 shows that channel structure 3 has a zigzag form and is moreover provided with a plurality of angular transitions from the one linear channel part to the adjacent linear channel part. Owing to the non-linear channel structure 3, the liquid for heating can be guided at a relatively high speed along a relatively large heating surface of heating element 4, whereby the liquid can be heated in a relatively efficient and intensive manner. Heating element 4 and base structure 2 of device 1 according to FIG. 1 are mutually connected in firm, durable and substantially medium-tight manner by means of a soldered connection 7. In the shown exemplary embodiment, the soldered connection may be limited to a (peripheral) soldered seam formed between base structure 2 and heating element 4.

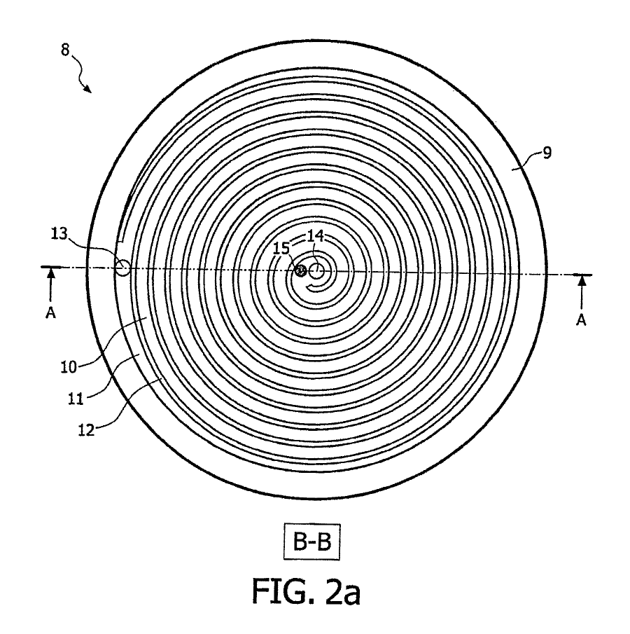

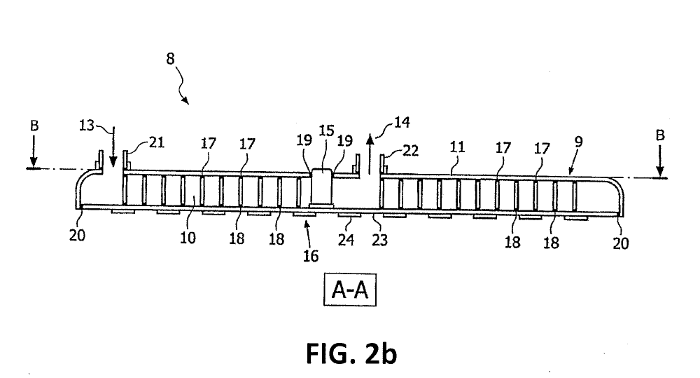

FIG. 2a shows a cross-section of a second exemplary embodiment of a device 8 according to the present disclosure. This cross-section represents a view along the line B-B as shown in FIG. 2b. Device 8 comprises a base structure 9 and a heating element connecting to base structure 9 (see FIG. 2b). Base structure 9 herein forms a spiral-shaped channel 10 for liquid for heating which is open on one side. Base structure 9 comprises for this purpose a base plate 11 on which a spirally oriented, upright dividing wall 12 is provided. Dividing wall 12 is adapted to bound channel 10 laterally. Both base plate 11 and dividing wall 12 are preferably manufactured from metal, in particular, stainless steel. Dividing wall 12 is preferably connected to base plate 11 in substantially medium-tight manner by means of a welded connection, in particular, a welded seam, a soldered connection, in particular, a soldered seam, and/or a brazed connection, in particular, a brazed seam (see FIG. 2b). In the shown exemplary embodiment, channel 10 is sealed in medium-tight manner by the adjacent heating element. In order to have dividing wall 12 connect to the heating element in firm, reliable and medium-tight manner, the heating element is preferably connected permanently to dividing wall 12 by means of a soldered or brazed seam. A peripheral seam of device 8 can be additionally sealed by means of a soldered connection or welded connection to enable improved medium-tightness of device 8. Channel 10 is provided with a supply 13 for liquid for heating and a discharge 14 for liquid heated by device 8. In order to enable relatively efficient connection of the heating element to base structure 9 by means of a soldered connection, a solder stick 15 is preferably arranged to enable mutual alignment (positioning) and mutual fixing of the heating element and the base structure 9.

FIG. 2b shows a cross-section along the line A-A as shown in FIG. 2a. Liquid can be introduced into device 8 via supply 13 and leaves the device via discharge 14 after passing through spiral channel 10. While running through channel 10, the liquid is heated directly, i.e., without interposing any other element, by the plate-like heating element 16 bounding channel 10. Since the channel section 10 is quite small (generally between 2 and 50 mm²), the liquid volume of device 8 is also relatively small. However, due to the efficient and intensive heat transfer from heating element 16 to the liquid, the liquid will be able to reach the desired temperature relatively quickly. In order to prevent overheating, in particular, boiling, of the liquid and to increase the capacity of device 8, the liquid will generally be pumped through device 8 at an increased pressure of between about 0.2 and 16 bar and at speeds preferably between 1 and 3 m/s. Device 8 has, however, been tested at a pressure of about 35 bar. A pressure of about 30-35 bar is relatively high and can only be applied in the case that dividing wall 12 is connected on one side to base plate 11 via a soldered seam 17, and is connected on an opposite side to heating element 16 via a welded or brazed seam 18. Solder stick 15 is also connected to heating element 16 by a welded connection 19, and to base plate 11 by a welded connection or soldered connection. Heating element 16 is connected to base plate 11 by means of a peripheral welded seam or soldered seam 20 in order to make device 8 medium-tight and pressure-resistant. As it runs through channel 10, the liquid will preferably cover a channel length of 0.5, 1, 2, 4, 5 or 6 metres. The actual liquid speed (distance per unit of time) through the channel 10 is depending on the dimensioning of the channel 10, in particular, the length and the cross-section, and moreover on the liquid flow rate (volume per unit of time), the liquid flow rate being determined and regulated by means of a pump (not shown), which pump is controlled by means of a control unit (not shown). The control unit determines the flow rate based upon both the desired increase of temperature of the liquid to be heated and the heating capacity (power) of the heating element 16. Heat can be transferred in relatively efficient and effective manner using the device because the assembly of base structure 11 and heating element 16 forms a thermally coupled and highly conductive whole. In order to be able to facilitate connection of device 8 to a supply conduit and discharge conduit, supply 13 and discharge 14 are each provided with a coupling structure 21, 22. Each coupling structure 21, 22 can be fixed to base plate 11 of base structure 9 by means of a welded connection or soldered connection. As shown in FIG. 2b, heating element 16 comprises a conductive plate 23, on a side of which remote from dividing wall 12 is arranged a thick film 24 (track-like electrical resistance) for generating heat.

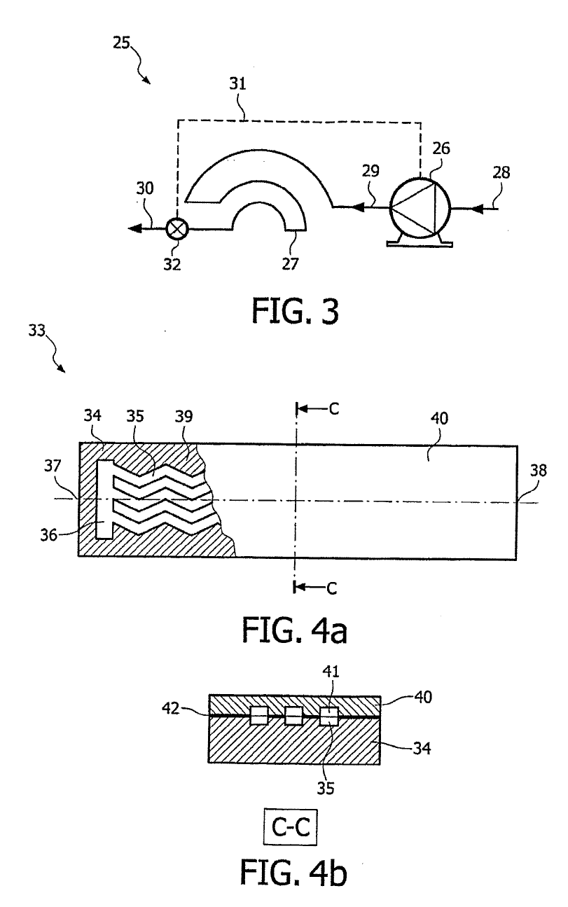

FIG. 3 shows a schematic representation of another exemplary embodiment of a device 25 according to the present disclosure. Device 25 herein comprises a pump 26 and a non-linear channel structure 27 connected to pump 26. Channel structure 27 is herein formed by a single channel which takes both a curved and angular form. Channel structure 27 herein connects to a thick film element (not shown) for heating a liquid, such as water, oil, flowing through channel structure 27. For this purpose, relatively cold liquid is first guided via a conduit 28 to pump 26, whereafter the relatively cold liquid is guided under pressure in the direction of channel structure 27 via another conduit 29. The conduit 28 filled with relatively cold liquid is preferably coupled to a public water supply system so that no separate storage tank with water is required. The liquid is heated in channel structure 27. The heated liquid can be removed from device 25 via a discharge conduit 30 and consumed by a user or used for other purposes. Device 25 is also provided with a temperature sensor 32 which is coupled to pump 26 via a conduit 31 and which is positioned in or close to discharge conduit 30 of channel structure 27. If sensor 32 detects that the liquid temperature exceeds a critical limit, commonly the heating element 25 will be switched off at least partially whereby overheating can be prevented. Optionally, the pump flow rate of pump 26 may also be adapted via a control unit (not shown) coupled to the sensor to further prevent overheating. Adjusting the power of heating element 25 can be realized here by applying a plurality of individually activated heating tracks (not shown). A similar (reverse) situation can occur when the liquid is heated insufficiently, whereupon the pump flow rate can be (temporarily) reduced. Device 25 is preferably also provided with an inlet sensor (not shown) whereby the temperature change of the liquid in channel structure 27 can be measured. In combination with measuring the power supplied to the liquid by device 25, it is then possible to determine the volume of the heated liquid supplied which may be relevant particularly in the case that a volume of, for instance, a hot drink is being dispensed.

FIG. 4a shows a partly cut-away top view of yet another exemplary embodiment of a device 33 according to the present disclosure. Device 33 comprises a support structure 34, which support structure 34 is provided on a top side with a plurality of recessed, non-linear channels 35 in parallel orientation, which channels 35 are mutually coupled on either side of support structure 34 by means of a collector 36. Channels 35 are adapted for throughflow of liquid and are provided with an inlet 37 and an outlet 38 for liquid. Another, flat part of the top side of support structure 34 is adapted to function as soldering surface 39 allowing the arrangement of a plate-like heating element 40 on the support structure so as to thus cover channels 35 in medium-tight manner. A flat part of the underside of heating element 40 also functions here as a soldering surface. Support structure 34 can be permanently connected to heating element 39 by applying solder paste to at least one of the soldering surfaces and then heating the soldering surfaces.

FIG. 4b shows a cross-section along the line C-C as indicated in FIG. 4a. FIG. 4b shows that a side of heating element 40 directed toward support structure 34 is also provided with three non-linear, identical (zigzag-shaped) channels 41. Channels 35 of support structure 34 connect over substantially the entire length to channels 41 of heating element 40. In this manner, the channel volume of device 33 can still be increased to some extent, wherein the heat transfer capacity of device 33 is at least maintained. This figure further shows clearly that the sides directed toward each other of support structure 34 and heating element 40, i.e., the contact surface of the two components 34, 40, is provided with solder 42 to enable mutual connection of components 34, 40.

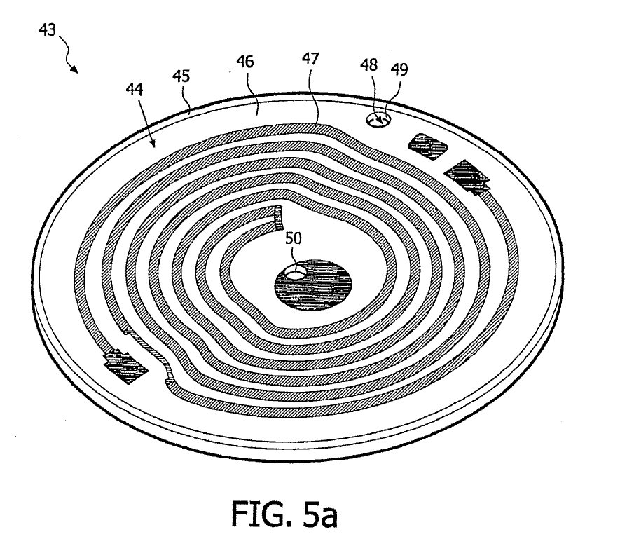

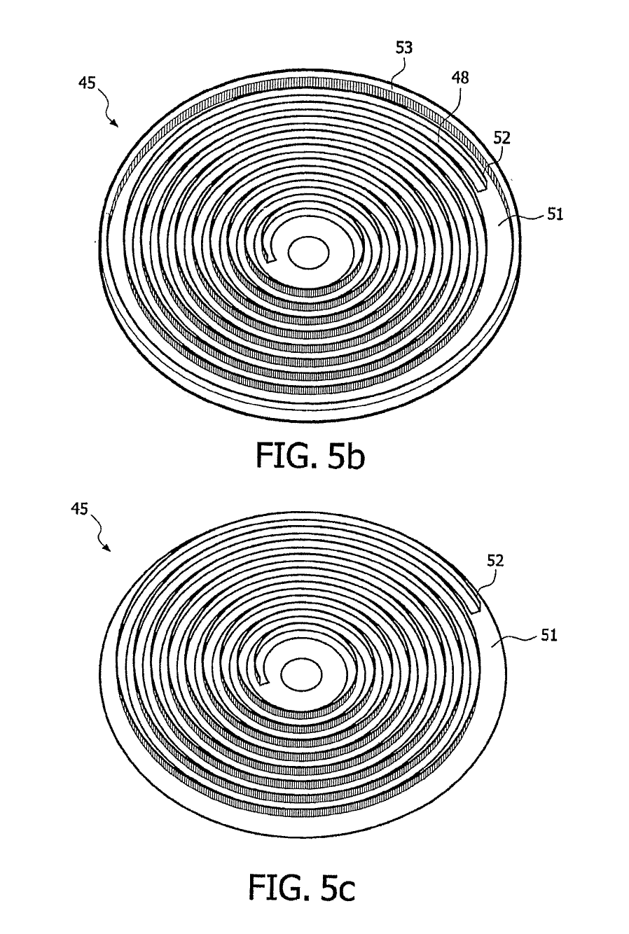

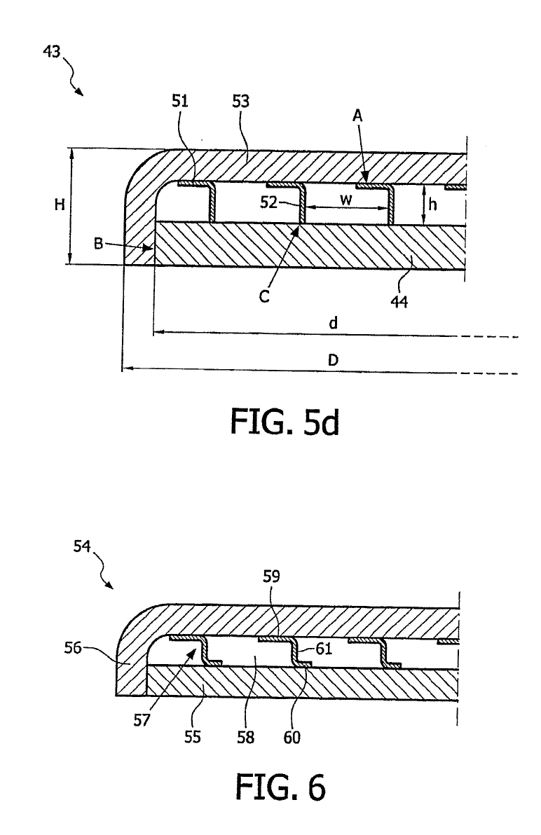

FIG. 5a shows a perspective view of an alternative exemplary embodiment of a device 43 according to the present disclosure. The device comprises a heating element 44, and a base structure 45 connected to the heating element. The heating element 44 comprises a dielectric layer 46 onto which a thick film heating track 47 is applied in a predefined pattern. The heating element 44 and the base structure 45 mutually enclose a substantially spiral shaped channel structure 48 for flowthrough of water (or any other liquid) to be heated. The heating element 44 is provided with an inlet 49 for water to be heated and an outlet 50 for heated water, wherein the inlet 49 and the outlet 50 are connected to opposite ends respectively of the channel structure 48.

FIG. 5b shows a perspective view of the base structure 45 of the device 43 shown in FIG. 5a. As shown, the base structure 45 comprises a base plate 51 provided with a dividing wall 52 being integrally connected to the base plate 51. The dividing wall 52 thereby defines the spiral shaped channel structure 48 through which water to be heated can be led along the heating element 44. The spiral shaped dividing wall 52 is formed by punching the original base plate 51 by means of a spiral shaped cutting die (not shown), after which the base plate 51 is partially deformed (bended) as to form the dividing wall 52 as shown. Both the base plate 51 and the dividing wall 52 are made of stainless steel in this illustrative example. The base structure 45 further comprises a covering element 53 enclosing or housing the base plate 51 and the dividing wall 52 partially. The base plate 51 is mechanically connected to the covering element 53 by means of laser welding or brazing. Commonly subsequently, the covering element 53 and an end surface of the dividing wall 52 are connected to the heating element 44 by means of brazing. The application of the spiral shaped dividing wall 52 being a former part of the original base plate 51 as shown in this figure commonly has multiple major advantages. A feature of the device as shown in FIGS. 5a-5d is that the dividing wall 52 can be positioned relatively accurately in a predefined manner which commonly improves the control of the device 43 during operation. Moreover, the covering element 53 and the dividing wall 52 can be brazed relatively quickly and efficiently in a single process step, wherein the device 43 can, for example, be led through a soldering stove to mechanically connect the heating element 44 with both the covering element 53 and the dividing wall 52. In this manner, a relatively high production rate can be achieved during manufacturing of the device as shown in FIGS. 5a-5d.

FIG. 5c shows a perspective view of a part of the base structure 45, in particular. the base plate 51 and the dividing wall 52, as shown in FIG. 5b. In this figure, it is clearly shown that the base plate 51 and the dividing wall 52 are integrally connected with each another and are constructed out of a single piece of plate material formed by the original base plate 51, wherein the dividing wall 52 is, in fact, formed by a bended part of the base plate 51. FIG. 5d shows a part of a cross-section of the device 43 shown in FIG. 5a. In this figure, it is shown that the base plate 51 and the dividing wall 52 are enclosed by the covering element 53 and the heating element 44. As mentioned before, the base plate 52 is connected to the covering element 53 by means of laser welding or brazing (see arrow A). The covering element 53 and the heating element 44 are brazed to each other (see arrow B). The end surface of the dividing wall 52 is also connected to the heating element 44 by means of brazing (see arrow C). In this illustrative example, the total height H of the device 43 is substantially 4.1 mm, and the height h of the channel structure 48 is substantially 1.5 mm. The total diameter D of the device 43 is substantially 82 mm, while the diameter d of the heating element 44 is substantially 80 mm. The width w of the channel structure 48 is substantially 3 mm in this illustrative example.

FIG. 6 shows a part of a cross-section of yet another alternative exemplary embodiment of a device 54 according to the present disclosure. The device 54 comprises a heating element 55, a housing 56 connected to the heating element, and a partition structure 57 positioned in between the heating element 55 and the housing 56. The partition structure 57 is substantially spiral shaped and adapted to realize a spiral shaped channel 58 within the device 54 adapted for flowthrough of water to be heated by the heating element 55. The partition structure 57 is made out of a die-cut and subsequently twice bended single piece of stainless steel and comprises a relatively large first flange 59, a relatively small second flange 60, and a partition wall 61 positioned in between the first flange 59 and the second flange 60. The first flange 59 is directed to the housing 56 and mechanically connected to the housing by means of laser welding or brazing. The second flange 60 is directed to the heating element 55 and mechanically connected to the heating element 55 by means of brazing. The flanges 59, 60 increase the contact surface area with the housing 56 and the heating element 55 respectively, and hence secure a reliable, durable and substantially medium-tight connection with these components 55, 56 of the device 54. The second flange 60 is kept relatively small to prevent, or at least to counteract, affection of the heat transfer efficiency of the heating element 55 towards water contained within the channel 58. With the device 54 as shown in this figure, water (or any other liquid) can be heated in a relatively efficient manner.

It will be apparent that the present disclosure is not limited to the exemplary embodiments shown and described herein, but that numerous variants, which will be self-evident to the skilled person in the field, are possible within the scope of the appended claims.

1. A device for heating liquids, comprising:
a) a base structure;
b) at least one heating element connecting to the base structure; and,
c) at least one non-linear channel structure arranged between the base structure and the heating element for throughflow of a liquid for heating;
wherein the base structure and the heating element are mechanically connected to each other.

2. The device of claim 1, wherein the base structure and the heating element are connected to each other by means of at least one soldered connection.

3. The device claim 1, wherein the soldered connection is formed by at least one soldered seam.

4. The device of claim 3, wherein the soldered seam extends along at least a part of a contact surface formed by the base structure and the heating element.

5. The device of claim 3, wherein the channel structure is bounded by at least one dividing wall, wherein the dividing wall is connected to the heating element via the soldered seam, while forming a seal for the channel structure.

6. The device of claim 5, wherein the base structure comprises a base plate on which the dividing wall is arranged by means of at least one welded connection.

7. The device of claim 5, wherein the dividing wall is at least partially formed by a deformed part of the base plate.

8. The device of claim 5, wherein the base plate and the dividing wall are substantially made of steel.

9. The device of claim 5, wherein the dividing wall has a thickness of between 0.1 and 0.8 mm.

10. The device of claim 1, comprising at least one shielding element for shielding the base structure at least partially, the shielding element being connected to the heating element and the base structure.

11. The device of claim 1, wherein at least a part of the channel structure is recessed into a side of the base structure.

12. The device of claim 1, wherein at least a part of the channel structure is recessed into the heating element.

13. The device of claim 1, wherein the channel structure has a substantially two-dimensional geometry.

14. The device of claim 1, wherein the channel structure has an at least partly curved form.

15. The device of claim 1, wherein the channel structure has a substantially spiral-shaped form.

16. The device of claim 1, wherein the heating element has a substantially plate-like form.

17. The device of claim 1, wherein the channel length of the channel structure is between 0.3 and 7 meters.

18. The device of claim 1, wherein the cross-section of the channel structure has a surface area lying between 1 and 100 mm².

19. The device of claim 1, wherein the channel structure has an at least partly angular form.

20. The device of claim 1, wherein the base structure is formed by a plurality of separate, mutually connected base modules.

21. The device of claim 1, further comprising a pump for pumping the liquid for heating through the channel structure under pressure.

22. The device of claim 21, wherein the pump flow rate of the pump can be regulated.

23. The device of claim 21, wherein the device is provided with a sensor coupled to the pump for regulating the pump flow rate subject to the liquid temperature in the channel structure.

24. The device of claim 23, wherein the sensor comprises:
a) at least one inlet sensor for detecting the temperature of the liquid supplied to the device; and
b) at least one outlet sensor for detecting the temperature of the liquid guided out of the device.

25. The device of claim 23, further comprising a control unit for regulating the pump flow rate based upon temperature related information gathered by the sensor.

26. The device of claim 1, wherein the device is adapted for coupling of the channel structure to a water main.

27. A method for heating liquids, comprising:
a) providing a device having a base structure, and at least one heating element connecting to the base structure, wherein at least one non-linear channel structure is arranged between the base structure and the heating element for throughflow of a liquid for heating, and wherein the base structure and the heating element are mutually connected by means of at least one soldered connection;
b) activating the heating element; and
c) guiding a liquid for heating through the channel structure.

28. The method of claim 27, wherein step b) takes place under increased pressure.

29. The method of claim 27, comprising:
c) detecting the temperature of the liquid at an inlet and an outlet associated with the channel structure.

30. The method of claim 29, comprising:
d) regulating the flow rate of the liquid guided through the channel structure in step b) based upon the at least one temperature detected in step c).

31. The device of claim 1, wherein the channel length of the channel structure is between 0.5 and 5 meters.

32. The device of claim 1, wherein the cross-section of the channel structure has a surface area lying between 2 and 50 mm².
